(19) United States
(12) Patent Application Publication
(10) Pub. No.: US 2005/0075943 A1
(43) Pub. Date: Apr. 7, 2005

(54) Method and arrangement for calculation of author royalties

(75) Inventors: Edmund Potsch, Konigsbrunn (DE); Rudiger Schulz, Bobingen (DE)

Correspondence Address: COHEN, PONTANI, LIEBERMAN & PAVANE;Suite 1210, 551 Fifth Avenue, New York, NY, 10176, US

(73) Assignee: Fujitsu Siemens Computers GmbH, Munchen (DE)

(21) Appl. No.: 10/914,784

(22) Filed: Jul. 26, 2004

Related U.S. Application Data
(63) Continuation of application No. PCT/DE03/00200, filed on Jan. 24, 2003.

(30) Foreign Application Priority Data
Jan. 25, 2002 (DE) 102 02 916.4

(51) Int. Cl. G06F 17/60

(52) U.S. Cl. 705/26

(57) ABSTRACT

A method and system for payment of the copyright levy for a copyrighted work in digital form permits and promotes copying and further distribution of the copyrighted work to customers who are encouraged to register and pay the copyright levy by the ability to collect a commission payment from subsequent customers to whom they in turn distribute copies of the copyrighted work. An information block that incorporates an identifier for each registered customer is associated with the copyrighted work and is utilized to determine to whom a commission payment is to be made when a subsequent customer registers and pays the copyright levy.

### CROSS-REFERENCE TO RELATED APPLICATION

This is a continuation of International Application No. PCT/DE2003/000200, filed on Jan. 24, 2003, which claims priority from German Patent Application No. 10202916.4, filed on Jan. 25, 2002 the content of which is hereby incorporated by reference.

### FIELD OF THE INVENTION

The invention relates to a method and arrangement for billing for the copyright levy when distributing copyright-protected works, as for example software products.

### BACKGROUND OF THE INVENTION

Copyright-protected works available in digital form, such for example as documents, music, films, pictorial representations and software products and the like, can be copied as often as desired without a loss of quality in the process. As used herein, the term “work” is intended to denote and include all such copyright-protected and protectable works that are available in digital form. The originator himself has a “copyright” over his work, which is to say that he himself can determine whether or not the work may be copied. If he allows copying, then he is entitled to an appropriate remuneration, i.e. a “copyright levy”. The problem is that copyright is difficult to enforce in practice.

To stop illegal copying of works, a few known solutions use “copy protection” for this purpose. This is intended to achieve a situation in which the work is obtainable only from authorized locations that pay the appropriate copyright levy to the originator. Copy protection is intended to prevent digital copying of the work.

By way of example, Microsoft plans to introduce compulsory online activation with the product Windows XP, so that there is the assurance that each copy of a work can be activated only once online, and that a license fee or copyright levy is incurred if there is further online activation of the same copy.

Further copy protection mechanisms are known through www.aladdin.de, such as the Hardlock system and concept for direct enabling or copy protection of works. ContentGuard technology (www.contentguard.com) provides an electronic ticket which basically allows the customer to use a work after he has paid for it.

The CSS (Content Scrambling System) is used for encrypting and decrypting DVDs, and can encrypt individual titles or an entire DVD. The encryption keys are stored on the DVD in encrypted form. A DVD player, provided that its hardware and/or software is/are CSS-compatible, requests the appropriate keys, checks whether the title or the DVD has been enabled for use, and, if appropriate, plays back the title in decrypted form. Every title and every DVD has its own key which is created using an algorithm that is known only to the CSS Licensing Authority, which has the task of looking after the appropriate copyright levy. CSS prevents playback of copies which do not have a correct key.

The aforementioned methods and systems prevent playback of a work if the customer does not have an appropriate hardware and/or software key authorizing him to do so. Generally, the key is provided in return for payment.

In addition, Macrovision also provides analog copy protection under the name APS (Analogue Protection System). This mechanism interferes with the analog signal that is output from the DVD player as it is recorded to create a copy on VHS tape. It is therefore based on the original DVD being able to be played back but any copy of the original DVD being withdrawn from interference-free use of the work.

In practice, these mechanisms are frequently bypassed using appropriately manipulated circuits, devices, software or products, which means that the originator still receives only a fraction of the appropriate remuneration as compared with that remuneration to which he is actually entitled.

In the professional sector, “exploitation companies” which administer the exploitation rights of originators of works, such as GEMA (the German “Gesellschaft für musikalische Aufführungs- und mechanische Vervielfältigungsrechte”, or society for musical performing and mechanical reproduction rights), ensure that the originator gets his proper remuneration. In the private sector, the making of copies is permitted in Germany under Section 54 of the copyright law. However, the ZPÜ, Zentralstelle für private Überspielrechte (the central office for private recording rights), as the umbrella organization for exploitation companies, is entitled to collect appropriate levies from manufacturers of appliances and media which are intended to copy protected works, these levies then being intended to be paid to the originators. A corresponding pan-European regulation is under discussion.

The present invention is concerned with the problem of the copyright levy when copying works.

### OBJECTS AND SUMMARY OF THE INVENTION

It is accordingly an object of the invention to provide a solution by which the originator receives a proper remuneration and which promotes distribution of the work.

In one embodiment of the invention, this object is achieved by providing a method for paying the copyright levy when distributing works, which includes the following steps:
a) a first customer enrolls with a copy provider using his customer-specific data;
b) the customer pays the copyright levy for a work to the copy provider;
c) an information block containing, inter alia, the customer-specific details or data—or, alternatively, at least an identifier linked or linkable to such data for that customer—is transferred to the customer, optionally with the work;
d) the work, including the information block, is copied and passed on to a further customer;
e) the further customer enrolls with the copy provider by sending to the copy provider both the information block with the customer-specific data of the customer from whom he has received the copy and his own customer-specific data, and pays the copyright levy;
f) the customer-specific data, and a linked or linkable identifier, of the further or new customer who has just enrolled are incorporated into the information block, and the resulting extended information block is transferred from the copy provider to the new customer; and
g) a commission payment is made by the copy provider to that customer identified in the information block who had been entered in the information block before the newly enrolled customer.

In another embodiment, the work to be copied is permanently provided with a “copy agent”. The copy agent is a software or computer program which, like the information block, is appended either at the start or the end of the digital work, or which is accommodated in appropriately linked form, with or without encryption, throughout the work. To embed the copy agent into the work, a steganographic technique may be used, for example, in which the copy agent is incorporated into the work without the user's knowledge or awareness. Alternatively, other encryption techniques may be employed.

The copy agent is activated whenever the work is to be stored by means of write access, transferred (e.g. as an attachment to an e-mail) or copied using another process. As soon as such a copy transaction, which is intended to involve the transfer from a source to a destination of a data stream for the work together with the copy agent contained therein, is identified, the copy agent is activated and announces itself on the computer from which or on which the copy transaction is to take place. The copy agent opens a dialog box and notifies the customer that he can register in order to create a copy and that, when passing on a copy, he has the opportunity to receive a commission if he registers with the copy provider. The copy agent provides the user with appropriate means for effecting such registration. If the customer does not wish to register, then although the copy is enabled, the customer-specific data of the copying customer are not recorded, which means that he does not appear (or is not otherwise identified) in the information block and can therefore receive no commission. In this case, the commission for later-enrolling customers is received by the predecessor registered customer, or by a plurality of such previous customers.

In one alternative embodiment, in which the originator does not wish to license a copy if the customer does not register, registration is an absolute prerequisite to use of the copy of the work. Registration can be done online over the Internet, by telephone or by mail, for example. Following registration, the customer receives from the copy provider a new information block containing his customer-specific data identifying the customer, which the customer inputs using the copy agent CA in order to add it to the information block for the work. As soon as the copy agent CA identifies a valid new information block, it enables the copy transaction. The information block expediently contains an encrypted integrity algorithm which the copy agent CA can use to check whether the information block comes from the copy provider. The copy of the work is created on the basis of the transaction required by the customer, or the copy of the work product is passed on as input by the customer.

The copy now contains the customer-specific data of the customer and the number of copies already drawn on these customer-specific data. By inputting his information block, the customer can create further copies, which increases the count in the information block with each copy operation. The customer can make copies for as long as any copying limit identified in the information block has not been reached. A commission for further subsequent copies is credited to the customer's commission account by the copy provider.

In implementing the invention, any suitable arrangement may be utilized for identifying to a user or customer of the work the copy provider to be contacted to register the work. By way of illustrative example, the information block, or a text or like file accompanying or associated with the work, may provide an address or link to a homepage of the copy provider or any other contact or identifying information or details sufficient to enable the user or customer to communicate with the copy provider to effect registration of the work. Similarly, an automated software program may be provided, in conjunction with the work, which when executed prompts the user or customer to input his identifying and payment information and automatically contacts and forwards such information to the copy provider. These and various other arrangements for facilitating contact between a customer and the copy provider, as a general matter of design choice, are within the intended scope and contemplation of the invention.

The object of the invention is likewise achieved by an embodiment in the form of an arrangement for paying the copyright levy when distributing works, which includes and/or utilizes:
a) a server on which a work is stored with an information block;
b) a computer belonging to a customer, which can be connected to the server by means of a network connection (e.g. a telephone line, cable or radio or the like) or the Internet;
c) enrollment and registration software on the server for recording of customer-specific data;
d) a communication program which incorporates the customer-specific data for the enrolling customer into the information block and sends the resulting information block to the enrolling customer, optionally with the work; and
e) a billing program which regulates payment of the copyright levy by the customer and, when payment has been made, makes a commission payment to a previous customer identified in the information block.

A copy's “family tree”, i.e. the customer-specific data or identifiers of the previous customers, can be stored entirely in the information block for the work itself and/or on the copy provider's server.

Hence, any customer who passes on a copy of the work to a further customer, with the further customer enrolling with the copy provider, receives a commission.

In accordance with an embodiment of the invention, the commission is paid only for direct conveyance to a further customer, which is to say that only the conveying customer receives a commission.

In on the other hand a further embodiment of the invention, a commission is also paid to those customers who are listed or identified in the information block in first or, alternatively, second place ahead of (i.e. earlier in time than) the conveying customer. Similarly, it is also contemplated that all customers listed or identified in the information block may be entitled to receive a commission.

By way of example, the level or amount of the commission payment may be limited to a maximum sum, such as the sum of the copyright levy.

Similarly, the commission may also be stipulated or set as a fixed sum for each conveyance in order to provide a further incentive for conveyance.

As described herein in connection with methods implementing the invention, the billing program for making the commission payment can operate either such that only the conveying customer receives a commission payment or such that all previous customers identified in the information block receive a commission payment on the basis of a certain stipulated key.

Paying a commission to only the directly conveying customer has the advantage that no customer obtains an advantage by obtaining the work directly from the copy provider since, instead, it is the conveying customer that is entitled to a commission payment as a result of his providing the copy.

If all customers identified in the information block get a share of the commission payment, then it is advantageous to stipulate the commission payment as a fixed sum and to likewise limit it to a certain maximum sum, so that again no customer is able to obtain an advantage by obtaining the work directly from the copy provider instead of copying it from a previous customer.

Embodiments of the invention are thus based on the existence of works of which the originator consciously wishes to sell as great a number of copies as possible. As such, the inventive arrangements and methods break away from the fundamental concept in the prior art that copying needs to be prevented. Instead, the invention consciously promotes copying and actively involves the copying customer in the distribution process by providing the technical prerequisites for the copying customer to obtain a financial advantage if he pays his copyright levy for the work that he has copied and ensures that the work is distributed further.

An embodiment of the invention with a copy agent can also be implemented in a modified or alternative manner. In contrast to known copy protection techniques which are intended to prevent use of a copied work if no authorization has been given, in such a modified embodiment the use of a copy which a new user receives from his predecessor is permitted and license-free. Not until the new user wishes to make a copy and pass on the work does the copy agent step in as described above. This results in a legal opportunity for use—in contrast to the prior art or the initial embodiment described, in which there is no prohibition and no illegal or restricted use—and hence in the opportunity to use the work to its full extent, thus promoting the further distribution of attractive works.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

Embodiments of the invention are explained in additional detail below with reference to the drawings, in which:

FIG. 1 is a block diagram of a method in accordance with a first embodiment of the invention;

FIG. 2 is a block diagram of an alternative embodiment in accordance with the invention;

FIG. 3 schematically depicts an arrangement for implementing the invention; and

FIG. 4 schematically depicts another arrangement for implementing the invention.

### DETAILED DESCRIPTION OF THE PREFERRED EMBODIMENTS

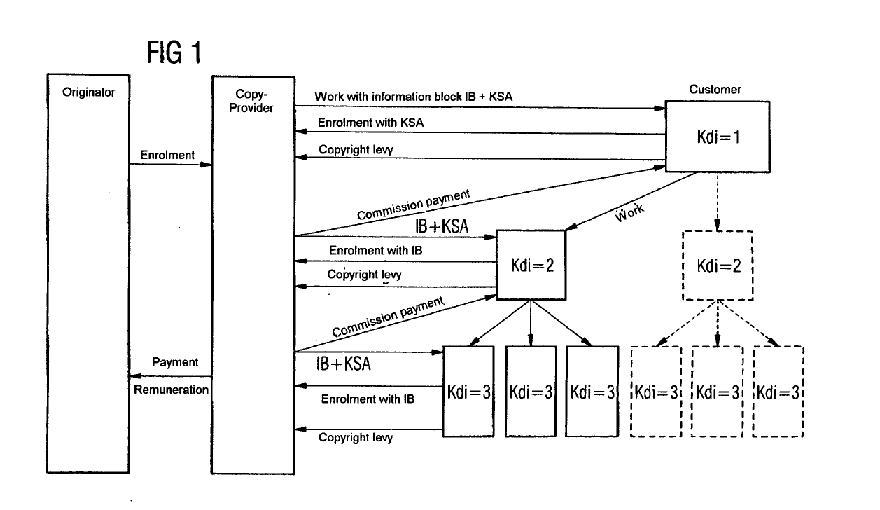

FIG. 1 is a block diagram depicting a method implementing a first embodiment of the invention. When an originator wishes to distribute his copyright-protected, digital-form work, he enrolls with a “copy provider” and sends his work to the copy provider. The copy provider stores the work on a server which can be accessed by potential customers, e.g. over the Internet.

A first customer (Kd i=1) wishing to purchase the work is able to enroll with the copy provider using his customer-specific data KSA and to pay the copyright levy, as for example using a credit card or a debit instruction. In return, he receives from the copy provider the work and, in addition, an information block IB which incorporates not only details specific to the work, such as the copyright or license, title and author, but also customer-specific data KSA. The customer-specific data should at a minimum include the customer name and identifying details of the customer's bank or the like to which commission payments to be paid to that customer should be directed. It may additionally include any other details of the customer as may be desired or necessary in accordance with particular embodiments of the invention or otherwise as a general matter of design choice.

If a second customer (Kd i=2) now copies the work from the first customer (Kd i=1), the second customer (shown in broken lines in FIG. 1) is actually operating the work without a license. If the second customer wishes to operate the work legally, he uses the information block IB to enroll with the copy provider and in turn pays the copyright levy to the copy provider in order to obtain an authorization for use of the work. In return, the second customer receives from the copy provider the information block incorporating his license and his customer-specific data KSA, which information the copy provider has incorporated into the information block for the work.

At the same time, the copy provider pays a commission payment to the first customer Kd i=1.

If a third customer Kd i=3 now in turn copies the work from the second customer Kd i=2 and this third customer Kd i=3 also wishes to operate the work legally, then this third customer in turn uses the information block IB to enroll with the copy provider and pays his copyright levy. In return, the third customer receives the information block IB with the new (third) customer-specific data KSA, his customer-specific data also having now been incorporated in the information block.

At the same time, the copy provider pays a commission to the second customer Kd i=2 from whom the third customer Kd i=3 has copied the work.

Alternatively, in lieu of incorporating the customer-specific data KSA for any particular customer, the information block can instead incorporate a customer identifier—such as by way of illustrative example a customer-specific enrollment number or code or the like—which links or is linkable to the remotely-stored customer-specific data KSA. Such customer-specific data may be stored in a database or other data repository maintained on, for example, the copy provider's server. It is, therefore, the intention that the customer identifier incorporated in the information block at least minimally provide the ability to uniquely identify the customer. The identifier can be implemented, as a general matter of design choice, by incorporating the customer-specific data KSA in the information block—as is described by way of illustrative example herein in connection with various embodiments and implementations of the invention—or by remotely storing the customer-specific data and incorporating in the information block only a customer-specific numeric or other identifier that links or is linkable to the remotely stored data, or in any other manner sufficient to enable, by examination of the information block, identification of a properly registered or enrolled customer. For purposes of describing and claiming the present invention herein, the term “customer specific data” refers to either the customer specific data or the customer specific identifier link or the like. It should be understood that such modifications in respect of any of the herein described embodiments are within the intended scope and contemplation of the invention.

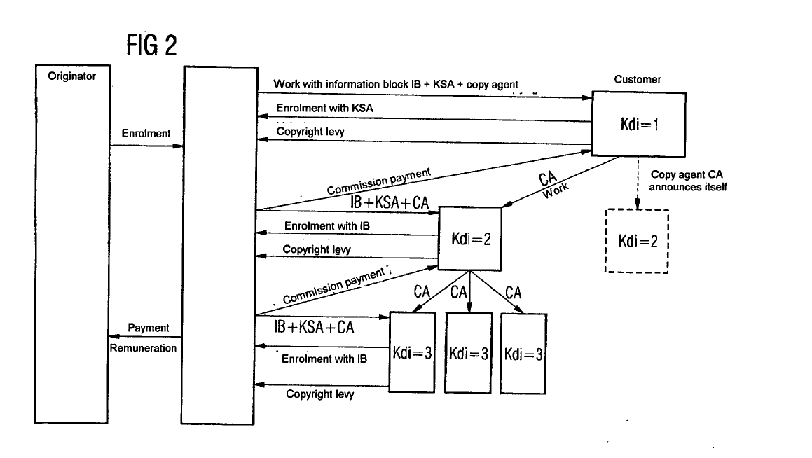

FIG. 2 depicts a modified embodiment of the inventive method in which a copy agent becomes active when a first customer (KD i=1) copies the work for a second customer (Kd i=2). It is only when a user or customer registers that he acquires a certain number of copyrights. Thus, in contrast to the embodiment of FIG. 1, the conveying customer operates the work legally and without restriction, even if he has not registered and payed the copyright levy. As in the FIG. 1 embodiment, the conveying customer does not receive his commission until a subsequent customer has registered with the copy provider. When the subsequent customer registers, he likewise obtains the right to distribute a certain number of copies and shares commission payments when further subsequent customers register. In this embodiment the customer-specific data KSA may additionally include the number of copies that the customer has the right to distribute by virtue of his registration with the copy provider.

In the embodiment depicted in FIG. 2 using the copy agent, a customer does not obtain permission and the ability to copy until he has registered. Hence, in this variation it is not possible to pass on the work to another without prior registration by the conveyer.

With both variants, only the directly conveying customer Kd i=2, or alternatively the previous customer Kd i=1, identified in the information block can receive a commission payment. On the other hand, it is contemplated that a commission payment may also be received by all customers who are listed or identified in the information block IB.

However, so as not to disadvantage those later-in-time customers who use the information block to enroll with the copy provider over customers who enroll with the copy provider as the first customer Kd=1, the assurance may also be provided that no advantage may be obtained by enrolling without an information block IB.

This assurance may be achieved, by way of example, by making the commission payment always limited to a fixed sum, e.g. to twice the copyright levy. Another option is for the commission payment to only be received from that customer to whom the work is conveyed directly.

If, by way of example, a customer does not enroll with the copy provider and operates the work without a license but still passes it on to another, then the commission payment will always be received by the person who appears last in the information block and has enrolled with the copy provider.

The copy provider ensures, firstly, that the commission is paid to the customers and, secondly, that the remuneration is paid to the originator.

Embodiments of the invention are thus based on the principle of providing a customer with a financial advantage through distribution of a copy of a work when that customer is included or identified in the information block as a result of payment of the copyright levy and hence receives his commission when distributing further copies.

The more attractive a work, the more customers will enroll with the copy provider in order to receive an appropriate commission for subsequent distributed copies. By way of example, a direct marketing strategy could be based on initial distribution of a particular number of free copies of the work in order to set the copying process in motion online and offline. In this case, a virtual customer Kd i=1 would be entered in the information block for the work. The virtual customer could be for example the copy provider himself or the originator.

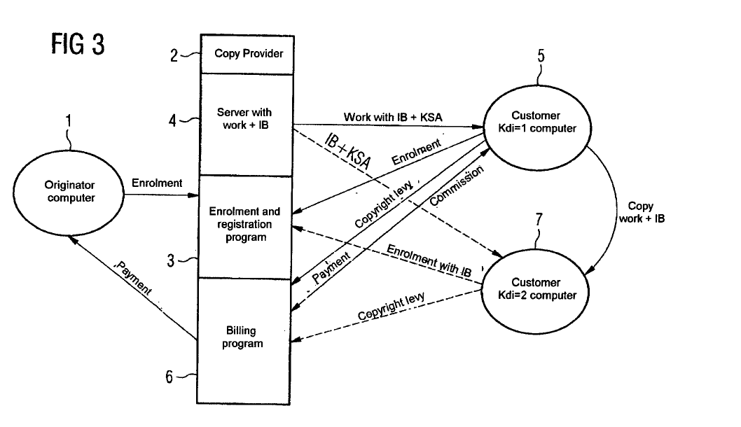

FIG. 3 depicts an arrangement in accordance with the invention for carrying out the method described herein with reference to FIG. 1.

The originator uses a computer 1 to enroll with the copy provider 2. By way of example, the originator enrolls over the Internet, and to this end the copy provider 2 provides an enrollment and registration program 3. Following enrollment, the originator uses his computer 1 to send his work and his identifying data, which the copy provider 2 requires in order to, for example, pay the copyright levy to the originator.

The copy provider 2 makes the work available, having provided it with an information block IB, on a server 4. If by way of example a first customer Kd i=1 is interested in the work, then he uses his computer 5 to enroll with the copy provider 2, such as over the Internet, and enters his customer-specific data KSA into the enrollment and registration program 3. He pays the copyright levy using a billing program 6 belonging to or hosted by the copy provider 2. Billing can be performed using a credit card or by means of normal invoicing, for example.

In return, the customer Kd i=1 receives from the copy provider 2, by means of the server 4, the work with the information block in which his customer-specific data KSA is included.

If a second customer Kd i=2 now copies the work from the first customer Kd i=1, the second customer initially operates the work without a license.

Should the second customer Kd i=2 wish to obtain a license and share in commission payments for further distribution, then he uses the information block IB to enroll with the copy provider 2 using the enrollment and registration program 3 and pays his copyright levy using the billing program 6. In return, he receives from the copy provider 2, by means of the server 4, the work with the information block in which his customer-specific data KSA or a customer-specific identifier are now also included, or alternatively such a new information block which is integratable with the copy of the work already in the second customer's possession.

The copy provider 2 uses the billing program firstly to pay a commission to the first customer Kd i=1 and also to pay the appropriate share of the copyright levy to the originator.

As the customer-specific data KSA is incorporated into the information block IB, which is sent either as a file with the work, or separately, by the copy provider, or also to the copy provider when further customers enroll, the customers are able to profit from further conveying the work, and hence the copy provider or the billing program can be used to make commission payments to those customers who have conveyed the work.

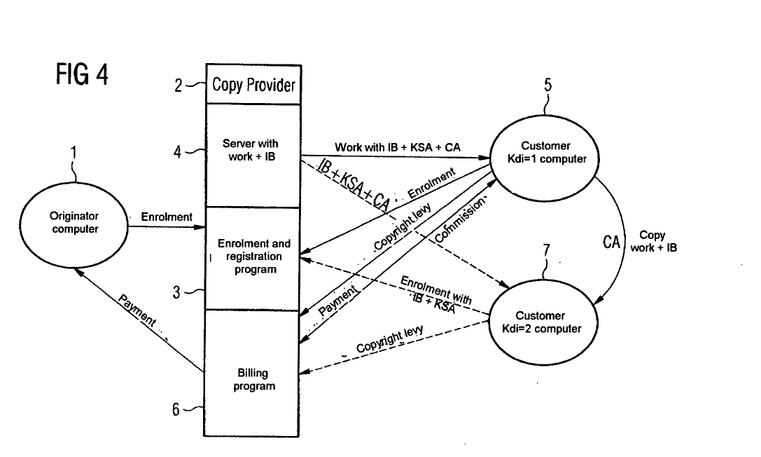

FIG. 4 depicts a modified arrangement for implementing an alternative method utilizing a copy agent, as was described above with reference to FIG. 2. In such an embodiment with a copy agent, registration provides each customer only with a particular number of rights to copy the work. If a customer does not register, he is not able to further distribute the work.

The copy agent CA is an integral part of the work, in the same way as is the information block IB. The copy agent CA appears automatically when the work is copied, and produces a dialog box for the customer and a connection to the copy provider CP. The customer uses the copy agent CA to send his customer-specific data to the copy provider CP, and receives the IB, entered into his copy, with the new KSA via the copy agent CA.

The server 4 runs a communication program which comprises the enrollment and registration program 3. The communication program enters the customer-specific data KSA sent by the customer by telephone, Internet, or mail or the like into the information block IB for the work and sends the result to the customer.

The copy agent may also be employed without an accompanying limitation on the permitted ability to make further copies of the work. In that case, its only function is to inform the copying customer and to possibly additionally establish a connection to the copy provider to enable or facilitiate registration.

While there have been shown and described and pointed out fundamental novel features of the invention as applied to a preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A method of paying a copyright levy for a copyrighted work in connection with distribution of the copyrighted work to and among customers of the copyrighted work, comprising the steps of:
enrolling with a copy provider, by a first customer for the copyrighted work, by providing the copy provider with customer-specific data of the first customer;
paying to the copy provider, by the first customer, the copyright levy for the copyrighted work;
transferring, from the copy provider to the first customer, an information block integrally associatable with the copyrighted work and that incorporates an identifier of the first customer;
creating, by the first customer, a copy of the copyrighted work and passing the copy of the copyrighted work to a second customer;
enrolling the second customer with the copy provider by sending to the copy provider, by the second customer, the information block and customer-specific data for the second customer and paying, by the second customer, the copyright levy;
incorporating, by the copy provider, an identifier of the second customer in the information block received by the copy provider from the second customer, to define an extended information block, and transferring the extended information block to the second customer; and
transferring a commission payment, for said payment of the copyright levy by the second customer, from the copy provider to the first customer identified in the extended information block.

2. A method of paying a copyright levy in accordance with claim 1, wherein the identifier of at least one of the first and second customers incorporated in at least one of the information block and the extended information block comprises the customer-specific data of the at least one of the first and second customers.

3. A method of paying a copyright levy for a copyrighted work in connection with distribution of the copyrighted work to and among customers of the copyrighted work, comprising the steps of:
associating with the copyrighted work an information block that incorporates an identifier of each customer that has registered the copyrighted work by providing a copy provider with customer-specific data of said each customer and the copyright levy for the copyrighted work, wherein the information block indicates an order-in-time in which said each customer has registered the copyrighted work;
providing to a customer an authorization to create a copy of the copyrighted work and to transfer the copy to a subsequent customer of the copyrighted work, wherein the transferred copy includes the associated information block; and
transferring, by the copy provider to at least one of the said each customer identified in the information block associated with the copyrighted work, a commission payment upon registration by the subsequent customer of the transferred copy of the copyrighted work.

4. A method of paying a copyright levy in accordance with claim 3, wherein the customer identifier in the information block comprises the customer-specific data.

5. A method of paying a copyright levy in accordance with claim 3, wherein said step of providing an authorization to a customer comprises providing to a customer an authorization to create a copy of the copyrighted work and to transfer the copy to a subsequent customer of the copyrighted work only upon registration by the customer of the copyrighted work.

6. A method of paying a copyright levy in accordance with claim 3, wherein only registered customers are identified in the information block so that no commission payment is transferred to an unregistered customer that has transferred a copy of the copyrighted work to a subsequent customer upon registration by the subsequent customer of the transferred copy of the copyrighted work.

7. A method of paying a copyright levy in accordance with claim 5, wherein initiating creation of a copy of the copyrighted work starts a copy agent associated with the copyrighted work that declares terms for payment of a commission payment to the copy initiator.

8. A method of paying a copyright levy in accordance with claim 7, wherein starting of the copy agent causes the copy agent to attempt a connection to the copy provider.

9. A method of paying a copyright levy in accordance with claim 3, wherein said transferring of the commission payment comprises transferring, by the copy provider to said each customer identified in the information block associated with the copyrighted work, a commission payment upon registration by the subsequent customer of the transferred copy of the copyrighted work.

10. A method of paying a copyright levy in accordance with claim 3, further comprising the step of providing, by the copy provider to a customer that registers the copyrighted work with the copy provider, authorization to create a predetermined number of copies of the copyrighted work.

11. A method of paying a copyright levy in accordance with claim 3, wherein said transferring of the commission payment comprises transferring by the copy provider a commission payment, upon registration by the subsequent customer of the transferred copy of the copyrighted work, to only the most recent-in-time each customer identified in the information block associated with the copyrighted work.

12. A method of paying a copyright levy in accordance with claim 3, wherein an amount of the commission payment is limited to a predetermined maximum sum.

13. A method of paying a copyright levy in accordance with claim 3, further comprising the step of transferring, from the copy provider to an originator of the copyrighted work, at least a portion of the copyright levy received by the copy provider from each registered customer of the copyrighted work.

14. A system for paying a copyright levy for a copyrighted work in connection with distribution of the copyrighted work to and among customers of the copyrighted work, comprising:
a server on which the copyrighted work is stored with an associated information block;
a computer of a customer, said computer being connected to said server for communication between said computer and server;
enrollment and registration software on said server for recording customer-specific data of a registering customer;
a communication program operable to incorporate, into the associated information block, one of the registering customer customer-specific data and an identifier of the registering customer to thereby define an extended information block, and for sending the extended information block to the registering customer; and
a billing program operable for regulating payment of the copyright levy by the registering customer and, upon payment of the copyright levy by the registering customer, for transferring a commission payment to a previous-in-time customer identified in the information block.

15. A system for paying a copyright levy in accordance with claim 14, wherein said communication program is further operable for sending to the registering customer the copyrighted work.

16. A system for paying a copyright levy in accordance with claim 14, wherein the communication program further comprises a copy agent transferable by the communication program with the extended information block.

17. A system for paying a copyright levy in accordance with claim 14, further comprising a copy agent that comprises a dialog program which operates between a customer and the enrollment and registration program and which is operable to automatically execute, upon initiation of a process to create a copy of the copyrighted work, to attempt a communication connection to the copy provider.

18. A system for paying a copyright levy in accordance with claim 14, wherein said billing program is further operable, upon payment of the copyright levy by the registering customer, for transferring a commission payment to each of a plurality of previous-in-time customers identified in the information block.

19. A system for paying a copyright levy in accordance with claim 14, wherein the commission payment is limited to a predetermined maximum amount.

20. A system for paying a copyright levy in accordance with claim 14, wherein the extended information block sent to the registering customer permits the registered customer to create a predetermined number of further copies of the copyrighted work.
